(19) United States
(12) Patent Application Publication
(10) Pub. No.: US 2019/0250780 A1
(43) Pub. Date: Aug. 15, 2019

(54) SELECTIVE USER NOTIFICATION OF ACTIONS TAKEN TO CONTENT BY OTHER USERS

(71) Applicant: Microsoft Technology Licensing, LLC, Redmond, WA (US)

(72) Inventors: Taili Feng, Bellevue, WA (US); Douglas Lane Milvaney, Somerville, MA (US)

(21) Appl. No.: 15/893,329

(22) Filed: Feb. 9, 2018

(51) Int. Cl. G06F 3/0484

(52) U.S. Cl. CPC G06F 3/0484

(57) ABSTRACT

Systems, methods, and software are disclosed herein to selectively notify a user of an action taken by other users on components of a collaborative document. A record is maintained of actions taken by users on a plurality of components of a collaborative document. An indication is then received of an action taken by a user on a component of the collaborative document. The record is evaluated to identify at least one other action taken by one other of the users on the component. In response to the evaluation of the record, the one other user is notified of the action taken by the user on the component of the collaborative document.

### TECHNICAL FIELD

Aspects of the disclosure are related to computing hardware and software technology, and in particular to notify a user of an action taken by other users on a component of a collaborative document.

### TECHNICAL BACKGROUND

Many software applications provide users with the capability to co-author and edit content in a collaborative document. These software applications include related data compiled into the document which may be added to or changed by any of the other users accessing the document within the same or different software application, such as in a cloud computing environment. These software applications provide advantages over traditional document editing, including traditional computer-based document editing (i.e., editing and exchanging different document versions amongst co-authoring users), in that it allows co-authors to simultaneously view added components and edits to existing components in the document that are being made by other co-authors in near real-time, while eliminating the need for users to send individual edit instances to one another, which may reflect outdated information when two or more users are editing a document at the same time.

Once a user has added, edited, of otherwise shown investment in a specific component of the collaborative document, the user may want to be notified if and when another co-author interacts with that component in the collaborative document. Unfortunately, current software applications do not enable users to proactively notify a user about changes made to relevant content by other users without indicating all of the changes made to the co-authored document. This limits an ability of the application to enhance a user experience when co-authoring a document amongst multiple users.

### OVERVIEW

An enhanced system, method, and software application are disclosed herein to improve notifying a user of an action taken by other users on a component in a collaborative document. A record is maintained of actions taken by users to a plurality of components of a collaborative document. An indication is then received of an action taken by a user on a component of the collaborative document. The record is evaluated to identify at least one other action taken by one other of the users on the component. In response to the evaluation of the record, the one other user is notified of the other action taken by the user on the component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture for implementing an enhanced application to notify a user of an action taken on a component in a collaborative document by another user.

FIG. 2 illustrates a notifying process employed in implementations of an enhanced application to notify a user of an action taken on a component in a collaborative document by another user.

FIG. 3 illustrates a time sequence of an enhanced application to notify a user of an action taken on a component in a collaborative document by another user.

FIG. 4 illustrates an exemplary data table in an implementation of an enhanced application to notify a user of an action taken on a component in a collaborative document by another user.

FIG. 5 illustrates an operational architecture in an implementation of an enhanced application to notify a user of an action taken on a component in a collaborative document by another user.

FIG. 6 illustrates an alternative operational architecture in an implementation of an enhanced application to notify a user of an action taken on a component in a collaborative document by another user.

FIG. 7 illustrates an alternative operational architecture in an implementation of an enhanced application to notify a user of an action taken on a component in a collaborative document by another user.

FIG. 8 illustrates a computing system suitable for implementing the technology disclosed herein, including any of the architectures, processes, operational scenarios, and operational sequences illustrated in the Figures and discussed below in the Technical Description.

### TECHNICAL DESCRIPTION

Examples of the present disclosure describe an application for notifying a user of an action taken by other users on a component in a collaborative document. A record is maintained of actions taken by users to a plurality of components of a collaborative document. An indication is then received of an action taken by a user on a component of the collaborative document. The record is evaluated to identify at least one other action taken by one other of the users to the component. In response to the evaluation of the record, the one other user is notified of the action taken by the user on the component in the collaborative document.

A technical effect that may be appreciated from the present discussion is the increased efficiency in identifying changes made to relevant content by other users (e.g., determining that text previous added to a co-authored document has been changed by another user) and providing a notification to the user interested in the relevant content without the user receiving notifications of all of the actions taken to other components in the collaborative document. The application described herein also improves efficiency by only notifying users of changes that the user is determined to be interested in without the user receiving notifications for each action taken to each of the components in the collaborative document.

Further, examples herein describe that the at least one other action taken by the one other of the users on the component comprises an addition of the component to the collaborative document. In other examples, the at least one other action taken by the one other of the users on the component comprises at least one of an edit, an insertion, a copy and paste, a duplication, a rearrangement, or a deletion of at least a portion of the component to the collaborative document. The action taken by the user on the component may also be at least one of a hover, a tap, a click, a screenshot, or a screen view for a timed duration on the component of the collaborative document. In a further example, the action taken by the user on the component of the item comprises the at least one other action taken by the one other of the users on the component comprises a suggested edit to the component of the collaborative document. Further in this scenario, the action taken by the user on the component of the collaborative document comprises an edit in response to the suggested edit to the component of the collaborative document.

In some implementations, the one other user is notified of the action taken by the user by indicating a typographical variation on the component of the collaborative document. In further examples, the one other user is notified of the action taken by the user by surfacing a summary of the action taken by the user on the component of the collaborative document. The one other user may also be notified of the action taken by the user by transferring a message to the user indicating that an action has been taken on the component.

In some examples, the record is evaluated to identify a plurality of other actions taken by the other users on the component. Further in this example, each of the other identified users of the action taken by the user on the component of the collaborative document are notified. In some scenarios, the record of actions taken by users to the plurality of components of the collaborative document is maintained in a cloud service application. In other scenario, the record of actions taken by users to the plurality of components of the collaborative document is maintained in a local service application. However, in even further examples, the record of actions taken by users to the plurality of components of the collaborative document is maintained in part on a cloud service application and in part on a local service application. The component may include a portion of text, a data entity card, an image, a table, a graph, an audio file, or a video clip.

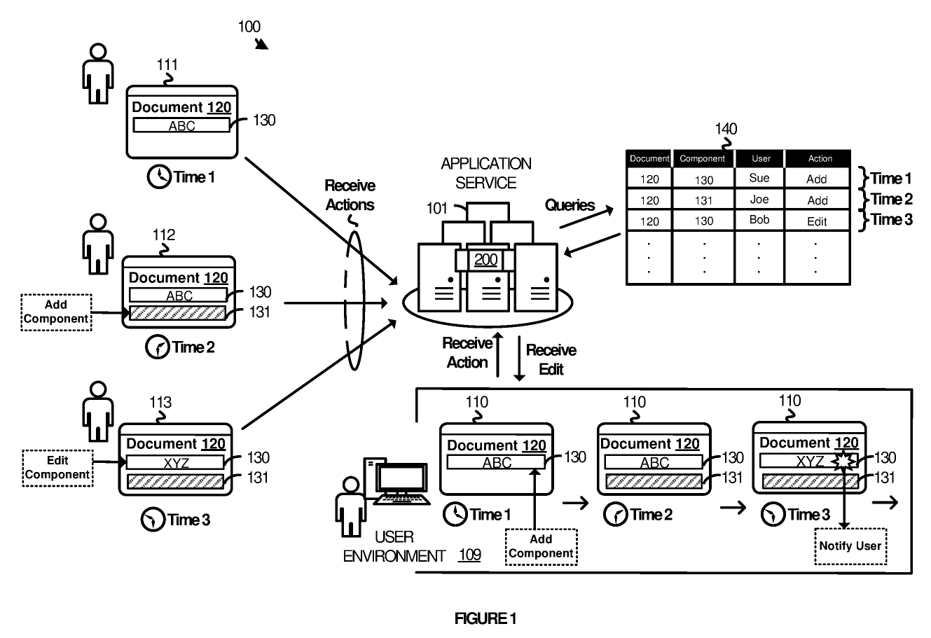

Referring to the drawings, FIG. 1 illustrates an exemplary operational architecture 100 related to processing operations for management of an exemplary enhanced system with which aspects of the present disclosure may be practiced. Operational environment 100 includes application service 101. Application service 101 employs a notifying process 200 in the context of producing views in a user interface 110 in a computing environment. User interface 110 displays components in a collaborative document to users produced by application service 101.

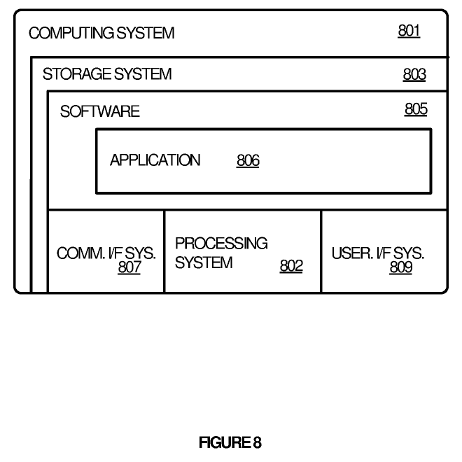

Application service 101 is representative of any device capable of running an application natively or in the context of a web browser, streaming an application, or executing an application in any other manner Examples of application service 101 include, but are not limited to, personal computers, mobile phones, tablet computers, desktop computers, laptop computers, wearable computing devices, or any other form factor, including any combination of computers or variations thereof. Application service 101 may include various hardware and software elements in a supporting architecture suitable for performing notifying process 200. One such representative architecture is illustrated in FIG. 8 with respect to computing system 801.

Application service 101 also includes a software application or application component capable of selectively indicating an action to components in a collaborative document in accordance with the processes described herein. Examples of the software application include, but are not limited to, presentation applications, diagramming applications, computer-aided design applications, productivity applications (e.g. word processors or spreadsheet applications), and any other type of combination or variation thereof. The software application may be implemented as a natively installed and executed application, a web application hosted in the context of a browser, a streamed or streaming application, a mobile application, or any variation or combination thereof.

User interface 110 includes a representative view that may be produced by a drafting application which may be co-authored by multiple users, such as Word® shared on SharePoint® from Microsoft®, although the dynamics illustrated in FIG. 1 with respect to user interface 110 may apply to any other suitable application. User interface 110 may display components, such as photos, text, tables, graphs, audio files, or video clips, for example. An end user may interface with application service 101 to view/hover on components, add components, edit/delete components, copy and paste components, insert components, move components, duplicate components, suggest edits on components, comment on components, or any other type of component management in collaborative document 120 presented in user interface 110. It should be noted that the user interactions with components 130-131 of collaborative document 120 are tracked and maintained a record (i.e., record 140).

The user may interface with application service 101 over user interface 110 using an input instrument such as a stylus, mouse device, keyboard, touch gesture, as well as any other suitable input device. The user may initiate a command to introduce components 130-131 into collaborative document 120, such as typing, copying and pasting, inserting, dragging and dropping, importing/exporting, etc. The user may also add comments and suggested edits to components of collaborative document 120 which were previously introduced into collaborative document 120 by another user interacting with collaborative document 120. In other scenarios, the user may hover, tap, touch, click, and view components 130-131 of collaborative document 120.

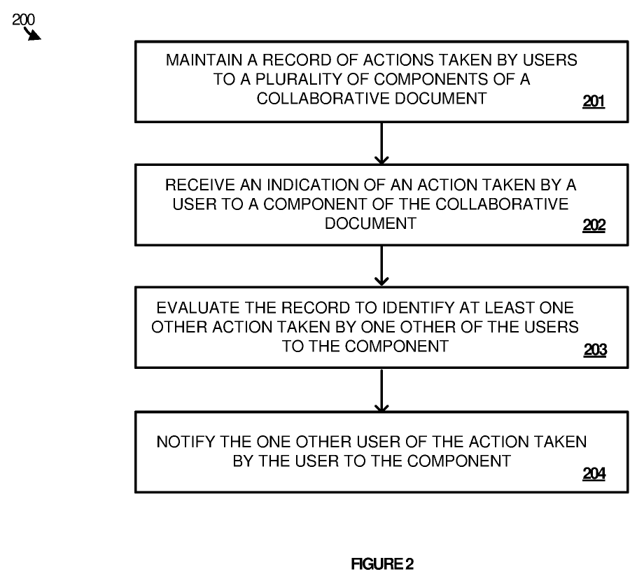

More particularly, FIG. 2 illustrates notifying process 200 which, as mentioned, may be employed by application service 101 to notify a user of an action taken to a component in a collaborative document by another user as described herein. Some or all of the steps of notifying process 200 may be implemented in program instructions in the context of a component or components of the application used to carry out the action notification feature. The program instructions direct application service 101 to operate as follows, referring parenthetically to the steps in FIG. 2 in the context of FIG. 1.

In operation, application service 101 maintains record 140 of actions taken by users 109 and 111-113 to a plurality of components of collaborative document 120. Collaborative document 120 may be a presentation, canvas or diagram, productivity document (e.g. word document or spreadsheet), and any other type of combination or variation thereof. Collaborative document 120 may be generated in application service 101 by a user. For instance, a user may create collaborative document 120 by uploading a template or generating the document from scratch including, but not limited to, electronic word documents, spreadsheets, photos, text messages, websites, media content, articles, handwritten notes written in digital ink, etc. Some exemplary applications are further configured to enable users to pull previously generated documents locally (e.g. from a storage of a specific computing device) or retrieve documents via a network connection (e.g. retrieve from a distributed storage, website, etc.). A user may then share collaborative document 120 with other users to co-author using a collaborative service application, such as SharePoint® or OneNote® by Microsoft®.

Although not illustrated in FIG. 1, it should be noted that the actions of the users may be maintained in the record (in whole or in part) using a native application, a web browser, a streaming application, a cloud application, or any other application in any other manner. Different records may be used to track actions taken to components 130-131 between users in the software applications. Record databases (i.e., record 140) may be found in a variety of applications, including text-based applications, spreadsheet applications, presentation applications, mobile applications, web applications, database applications, and graphic design applications, and may be especially useful in the context of document drafting and formatting.

Application service 101 may insert various components into collaborative document 120. For instance, a user may introduce components 130-131 by uploading or attaching components from various source documents including, but not limited to, electronic word documents, spreadsheets, photos, text messages, website links, media content, articles, notes written in digital ink, etc. Some exemplary applications are further configured to enable users to pull components locally (e.g. from a storage of a specific computing device) or retrieve components via a network connection (e.g. retrieve components from a distributed storage, website, etc.).

Application service 101 may receive user input indicative of the command to perform an action on a component by receiving user input in user interface 110. Application service 101 may then store the action taken to the component in record 140 in the software application based on the received user input. Application service 101 may receive the user input using an input instrument such as a stylus, mouse device, keyboard, touch gesture, as well as any other suitable input device. The users may introduce components 130-131 into collaborative document 120 by typing, copying and pasting, inserting, dragging and dropping, importing/exporting, etc. Components 130-131 may be a portion of text, a data entity card, an image, a table, a graph, a data range, an audio file, a video clip, and the like.

For example, user 109 may introduce component 130 into collaborative document 120 at Time 1 by typing a portion of text, such as “ABC”, into collaborative document 120. In response to receiving the introduced component 130, application service 101 synchronizes the latest versions of collaborative document 120 with users 111-113. Application service 101 also records the action (the introduction of component 130) in record 140 along with an identity of user 109. User 109 is now considered interested in being alerted of any further actions taken to component 130 by other users 111-113.

In some implementations, user 109 may also be considered to be interested in being alerted of any further actions taken to component 130 by other users 111-113 if user 109 performed an edit on component 130. Other actions that may indicated that user 109 should be notified by an action taken to component 130 by users 111-113 is if user 109 performed a command on component 130, such as a copy and paste command, a drag and drop command, a duplication command, a rearrangement or moving of component 130, a deletion of at least a portion of component 130, and the like. In some scenarios, component 130 may be considered relevant to user 109 if user 109 performed a hover, a tap, a touch, a click, or a screen view for a timed duration on component 130 of collaborative document 120. In some scenarios, user 109 may be considered interested in component 130 by suggesting an edit to component 130. User 130 would then be notified of an edit made by another user in response to the suggested edit made by user 130.

In a next operation, application service 101 then receives an indication of an action taken by a user on a component of the collaborative document (step 202). Application service 101 may be configured to enable users to perform various actions on components of collaborative document 120. Users 111-113 may perform actions on components 130-131 of collaborative document 120 by editing, copying and pasting, duplicating, rearranging, exporting, taking a screenshot, etc. For example, user 111 may add component 131 at Time 2. Next, at Time 3, user 112 edits component 130 to say “XYZ”, instead of “ABC”, which was previously added by user 109. In response to receiving the indication of the action taken by users 111-113, application service 101 may synchronize the latest version of collaborative document 120 and update record 140 of the actions and the associated user.

In a next operation, after the indication of the action taken by the user on the component is received, application service 101 evaluates the record to identify at least one other action taken by one other of the users to the component (step 203). Referring still to FIG. 1, application service 101 may determine that the addition of component 131 by user 111 to collaborative document 120 is not of interest to user 109. However, application service 101 may evaluate record 140 to determine that the edit made to component 130 by user 112 is of interest to user 109 based on the action previously taken on component 130 by user 109 and maintained in record 140.

Application service 101 may query record 140 for any actions taken to components of interest (i.e. component 130) by periodically identifying the latest version of components 130-131 of collaborative document 120. Application service 101 may also query record 140 when an action is made to component 130 of collaborative document 120. In other situations, application service 101 may query record 140 for any actions made to component 130 when the interested user 109 interacts with collaborative document 120, such as when collaborative document 120 is saved, re-opened, shared, emailed, re-located in a storage system, etc. Record 140 may also be queried for actions taken by other users to relevant component 130 when instructed by a user, such as by a user command to see any recent actions from users on components that are of interest to the user.

Application service 101 may also allocate the component as live or static. If the component is allocated as live, the component may be tracked in collaborative document 120 for changes made by other users. If the component is allocated as static, the component will not be tracked in collaborative document 120 for actions taken by other users. It should be noted that application service 101 may also allocate the component as live for certain changes made by users, but as static for other changes made by users. For example, component in the form of added text, such as component 130 in collaborative document 120, may be live to monitor for edits made to the text in component 130, but not be static for other actions made to component 130, such as a copy and paste.

In a final operation, if an action has been identified with at least one other action taken by one other of the users to the component, application service 101 notifies the one other user of the action taken by the user on the component. For example, application service has determined that the action taken by user 111 to add component 131 would not require a notification to user 109. However, the action made by user 112 to edit component 130 would require a notification to user 109. Application service 101 may notify user 109 of the one other action by displaying an icon, a toolbar indicator, a typographical variation (e.g., highlighting, shading, bolding, underlining, size enlargement or reduction), an animation, or any other technique to alert a user of the change to the component in the collaborative document.

The indication may also be displayed in the form of a summary card or an activity log associated with collaborative document 120. The summary card or activity log may additionally display an explanation or a preview of the action taken to component 130 by user 112 (i.e., user 112 has edited “ABC” to “XYZ”). In other implementations, application service 101 may further notify user 109 of the action taken by user 112 to component 130 by transferring user 109 a notification message. The notification message may be a ping message sent to user 109 when the user is using application service 101. The notification message may also be the form of an email message, text message, user sharing and collaboration application message, an internet instant message application alert, or any other notification message service message which may be used to alert user 109 of the actions taken to component 130. For example, users drafting a co-authored document in a shared document editing application may be alerted of a change to a text block which user 109 is interested in the form of a ping message in the application. Further, users not currently viewing collaborative document 120 or currently active in application service 101 may receive a notification message in the form of an email or text message indicating component 130 of collaborative document 120 has been changed by one or more of the other users 111-113.

In some scenarios, the display of the indication may be toggled on or off depending on a user command or user preference setting. For example, user 112 may be associated with component 131 since user 112 added component 131 to collaborative document 120. However, user 112 may toggle notifications off for component 131. It should be noted that notifications may be toggled off for actions made to components of interest on a case-by-case basis, or be toggled off for all actions made to components of interest. In further examples, actions made to all components may be indicated to a user. However, the indication of the actions to the components of interest may be indicated in a different manner than those components that have not been recorded as relevant to the user. For example, user 109 may view edits made to component 130 in the form of a summary card, but view edits made to component 131 in the form of bolded text.

In some examples, the type of indication used to notify a user may be determined based on a current status of the user. For example, when user 109 is currently interacting with collaborative document 120 using application 101, user 109 may be notified of the change to component 130 using an application-based notification, such as a highlighting action, a pop-up summary card, or a ping message in application 101. However, when user 109 is not currently interacting with collaborative document 120, user 109 may be notified using an external notification system, such as a text message or an email message. In some scenarios, user 109 may only be notified of the action to component 130 by another user when user 109 re-opens or resumes interactions with collaborative document 120.

In other scenarios, user 109 may be notified of the action taken on component 130 by other users over multiple notification methods. For example, user 109 may receive a text message that component 130 of collaborative document 120 has been edited another user. Once user 109 re-opens collaborative document 120, component 130 may also be shaded or an icon may be visible on component 130 indicating that an action has been taken on component 130. The type of notification, the number of notifications, the components that require notifications, and the timing of notifications may be determined by an algorithm defined in application service 101, by each of the users co-authoring collaborative document 120, and any other method of allocating notification preferences—including combinations thereof.

In some implementations, record 140 may track whether the user has acknowledged the notification or interacted with the component in response to the notification to determine whether future notifications associated with the component should be performed. For example, if user 109 is sent a notification that component 130 in collaborative document 120 has been edited but does not view the edit, record 140 may indicate that user 109 is not interested in actions made to component 130 and de-allocate user 109 as an affected user of actions taken on component 130 by other users.

In other scenarios, record 140 may maintain data indicating which types of actions taken on component 130 that user 109 is interested in receiving notifications. For example, is user 109 is alerted that component 130 has been copied and pasted and user 109 ignores the notification, record 140 may indicate that user 109 is not interested in being alerted of future copy and paste actions taken on component 130. However, when user 109 is notified that that component 130 has been deleted in part, user 109 may open a preview of the deletion indicating that user 109 is interested in this type of action on component 130.

Record 140 may also maintain similar data associated with which users taking actions on component 130 are of interest to user 109, as well as general actions and users that user 109 takes interest in. For example, user 109 may indicate that a notification is required for any actions performed by user 112, even if the action is not taken on a component of interest for user 109. Likewise, user 109 may indicate that a notification is required for any screenshot actions taken on components in collaborative document 120, even if the action is not taken on a component of interest for user 109. These rules and methods of notifying a user may be selected based on user preferences. However, application service 101 may also track user behaviors and historical user data to determine which components are relevant to a user, which actions by other users affect the user, which other users are of interest to the user, and how each of the actions for each of the component by each other user is communicated to the affected user.

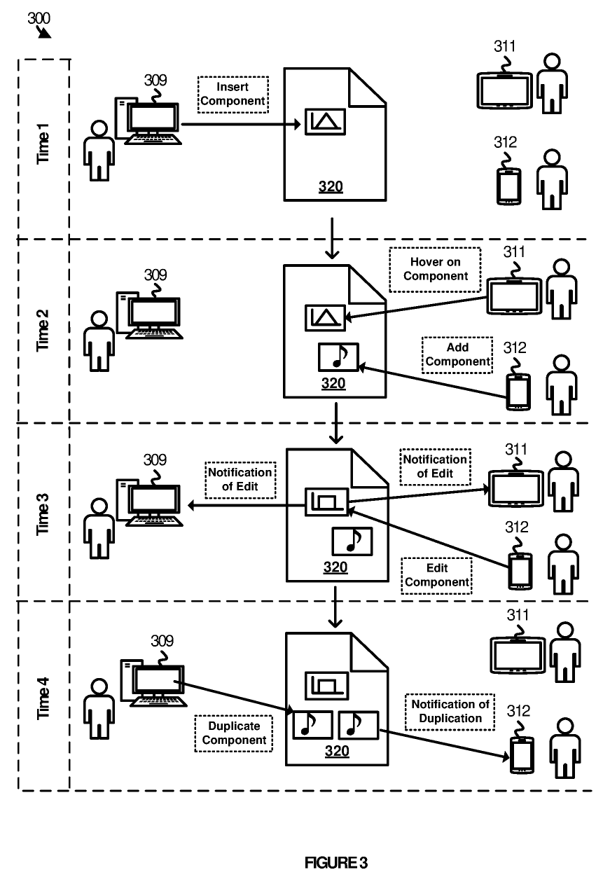

FIG. 3 illustrates a sequence diagram 300 which may be employed by an application service to notify a user of an action taken on a component of a collaborative document by another user as described herein. Sequence diagram comprises four timesteps illustration actions performed on collaborative document 320 by users 309, 311, and 312. In operation, user 309 initially adds a component to collaborative document 320. For example, at Time 1, user 309 inserts a graph into collaborative document 320. Although not shown in FIG. 3, a record is maintained of the insertion of the graph by user 309 at Time 1. Document 320 is synchronized across each user's version of document and users 311-312 are able to view the added graphical component to collaborative document 320.

At Time 2, user 311 hovers on the graphical component of collaborative document 320. In this example, the action of hovering on the graphical component by user 311 indicates that user 311 is interested in the graphical component. Also at Time 2, user 312 adds an audio file to collaborative document 320. However, neither action of hovering on the graphical component nor adding the audio file component require a notification to be made to user 309. It should be noted that although the added audio file is not relevant to user 309 or user 311, it is still added to the version viewed by user 309 and user 311 of collaborative document 320.

In a next operation, at Time 3, user 312 edits the graphical component previously added by user 309 at Time 1 and hovered over by user 311 at Time 2. As can be seen in sequence diagram 300, the edit made by user 312 to the graphical component triggers a notification to be sent to both user 309 and user 311. Next, at Time 4, user 309 duplicates the audio file component previously added by user 312. At this point, user 312 is notified of the duplication made by user 309 on the audio file component of collaborative document 320. However, since user 312 is not associated with the audio file component, user 312 would not be notified of the duplication made to the audio file component.

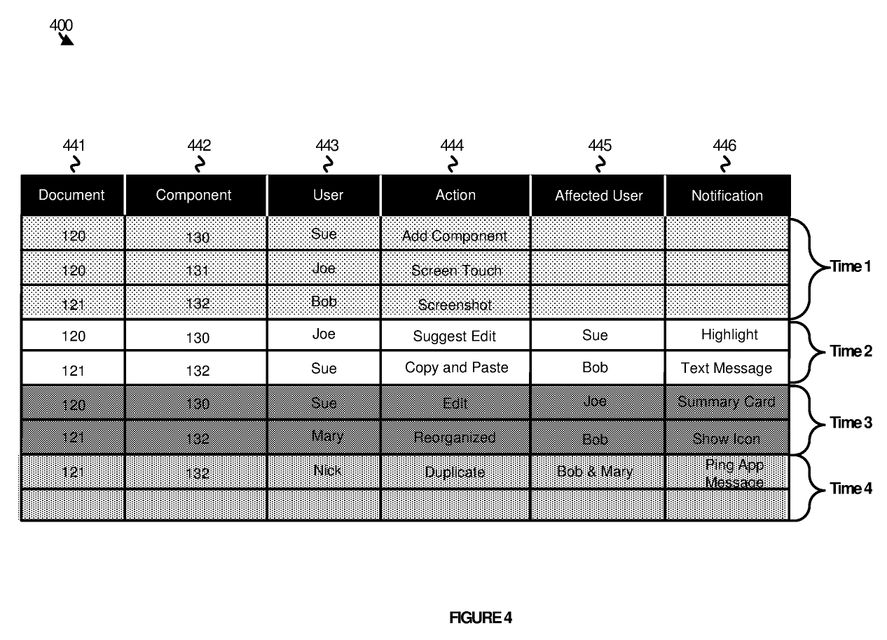

FIG. 4 illustrates data table 400 in more detail where exemplary actions are tracked for each component in a collaborative document, as well as exemplary affected users and notification preferences for each column and different phone numbers for each row. The collaborative document in column 441 of table 400 and are at least somewhat representative of a particular text documents, spreadsheet, presentations, and other co-authored documents that is shared between various users. With respect to the components in column 442, each component indicates a portion of text, a data entity card, an image, a table, a graph, an audio file, or a video clip, although other component types are possible and may be considered within the scope of the present disclosure.

The users in column 443 are the users recorded as performing the action indicated in column 444 on the components of column 442. The actions may be any user initiated command performed on the component, such as an addition, an insertion, a copy and paste, a hover, a screenshot, a suggested edit, a comment, a reorganization, or a view of a duration of time on the component, etc. The affected users of column 445 represent those users who have previously interacted or indicated an interest in actions performed on the component by other users. While various changes and actions are being performed by users on the components of the collaborative document, only the affected users are alerted of the change to the component. It should be noted that each of the users may be alerted of each action taken by each user at the affected user's instructions. However, the changes that are not relevant to the affected user may be indicated in a different manner than those changes made to relevant components of the collaborative document.

Still referring to FIG. 4, the notifications of column 446 indicate how the affected user is notified by each of the actions on each of the relevant components. The notifications may be specified by an affected user. For example, an affected user may want to be alerted via text message as soon as an action has been taken to a relevant component of the collaborative document. In other examples, the notification may depend on the type of action taken by the other user. For example, a user may want to be alerted via an icon in the application when a component of interest is reorganized. However, the user may want to receive a text message if the component is copied and pasted to another location in the collaborative document. As illustrated in FIG. 4, more than one user may be interested in actions taken on a component by other users. Therefore, there may be a plurality of affected users which would receive a notification of the action taken by the other user on the component of the collaborative document.

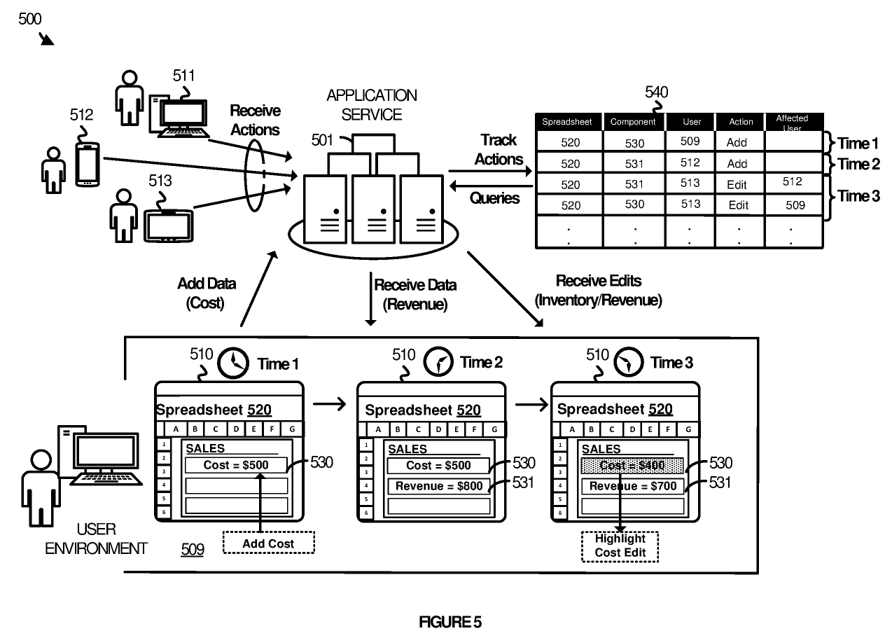

FIG. 5 illustrates an exemplary operational architecture for notifying a user of an action taken to a component of a collaborative document by another user that may be used in one or more scenarios of the present technology. FIG. 5 illustrates an operational scenario 500 that relates to what occurs when data added to a spreadsheet by the user is edited by another user and the user desires to be alerted of the change. Operational scenario 500 includes application service 501, user interface 510 in user environment 509, and other users 511-513. User interface 510 displays spreadsheet 520 which is co-authored by user 509 and users 511-513. Operational scenario 500 also includes record 540 to track and maintain actions taken on components by users 509 and 511-513. In this example, record 540 is maintained in a cloud-based environment.

In a first operation, spreadsheet 520 is created and shared in application service 501. Each of users 509 and 511-513 may then access and interact with spreadsheet 520. In this scenario, spreadsheet 520 is displayed to user 509 in user interface 510. In a next operation, at Time 1, user 509 adds data to spreadsheet 510. For example, user 509 added “Cost=$500” to create component 530. The data may be added by user 509 in a local environment or in a cloud-based environment. The data is then accessible to be viewed by other users sharing co-authored spreadsheet 520. For example, the user may post the data entry into a document sharing environment which may be accessed by users via application service 501.

In a next operation, the action taken to component 530 in spreadsheet 520 is tracked and maintained in record 540. For example, at a first-time interval, record 540 indicates that a component has been added to spreadsheet 520 by user 509. Since no other users are related to component 530 at this time, there are no affected users. It should also be noted that the added component 530 is shared and synchronized amongst other 511-513. At Time 2, one of the other users, such as user 512, adds another new component 531. For example, after seeing that user 509 has added the cost of $500 to the spreadsheet, user 512 adds another data entry indicating “Revenue $800.” Once again, record 540 tracks the addition of component 531 and determines that no other users are related to added component 531.

At Time 3, user 513 takes actions on both component 530 and component 531. For example, user 513 may edit the revenue data entry of component 531 that is associated with user 512. User 513 may also edit the cost data entry of component 530 that is associated with user 509. For example, user 513 may edit cost to be $400 instead of $500. Likewise, user 513 may edit revenue to be $700 instead of $800. These edits are then synchronized across each version of spreadsheet 520 displayed to users 509 and 511-513. The actions taken to each of components 530 and 531 are also tracked in record 540. At this point, the actions maintained in record 540 indicate that the edit made to component 531 affects user 512 and the edit made to component 530 affects user 509.

In this example scenario, application service 501 may then send a notification to user 509 indicating the edit made to component 530 (cost) and may not indicate the edit made to component 531 (revenue). In other scenarios, application service 501 may notify user 509 of the edits made to each of component 530 and component 531. However, in this scenario, the notification may indicate the edit to component 530 in a more visually prominent manner than the indication of the edit made to component 531 since user 509 is associated with component 530 and not component 531. In this example, the notification is indicated to user 509 in the form of a highlighting on edited component 530 in spreadsheet 520. The highlighting on component 530 indicates that an edit has been made to the cost which was previously added by user 509. Therefore, user 509 may be more interested in the action to component 530 than other actions made to other components in spreadsheet 520, such as component 531 which is merely updated in the view displayed to user 509 but not highlighted in the view displayed to user 509 in user interface 510.

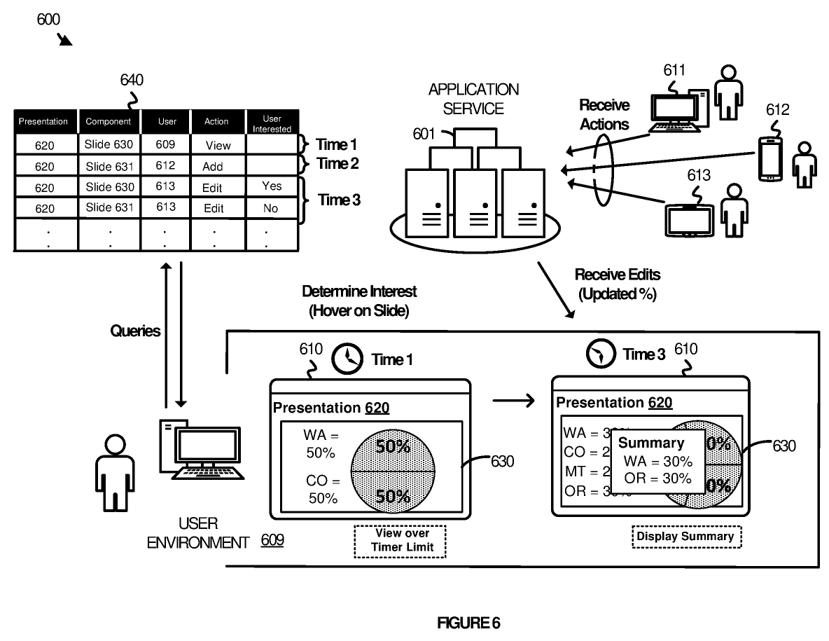

FIG. 6 illustrates an exemplary operational architecture for notifying a user of an action taken to a component in a collaborative document by another user that may be used in one or more scenarios of the present technology. FIG. 6 illustrates an operational scenario 600 that relates to what occurs when a user shows interest in a component which is updated by one of the other users. Operational scenario 600 includes application service 601, user interface 610 in user environment 609, and other users 611-613. User interface 610 displays presentation 620 which is co-authored by user 609 and users 611-613.

Operational scenario 600 also includes record 640 to track and maintain actions taken on components by users 609 and 611-613. In this example, record 640 is maintained in a native application service environment for user 609. Therefore, the cloud-based portion of application service 601 pushes updates made by each of users 611-613 to the native application environment for user 609. Additionally, record 640 may track additional actions made by user 609 which may indicate that user 609 is interested in a component. For example, record 640 may track a hover, a screenshot, a touch, or a screen view for a duration of time made by user 609. Additionally, the actions made by each of users 611-613 to components (i.e., slides) in presentation 620 are tracked at least in part at a local level in the native application environment.

In a first operation, presentation 620 is created and shared in application service 601. Each of users 609 and 611-613 may then access and interact with presentation 620. In this scenario, presentation 620 is displayed to user 609 in user interface 610. In a next operation, at Time 1, user 609 shows interest slide 630 in presentation 620. For example, user 609 may place slide 630 in view for a duration over a timer limit which indicates that user 609 would likely want to be alerted of future edits made to slide 630.

In a next operation, the action taken to slide 630 in presentation 620 is tracked and maintained in record 640. For example, at a first-time interval, record 640 indicates that a component has been marked at relevant in presentation 620 by user 609. Since no other actions related to slide 630 have been received at this time, no notifications are determined for user 609. It should also be noted that the view action made by user 609 may be stored locally only and not in a record maintained by the cloud environment application or the native application maintained locally by other users 611-613. However, the action made by user 609 may also be stored in a cloud-based environment.

At Time 2, one of the other users, such as user 612, adds a new slide 631. Once again, record 640 tracks the addition of slide 631 and determines that user 609 is not affected by the addition of slide 631. At Time 3, user 613 takes actions on both slide 630 and slide 631. For example, user 613 may edit the statistics displayed on slide 630. User 613 also makes edits to slide 631 (not shown). These edits are then synchronized across each user version of presentation 620. The actions taken to each of slide 630 and slide 631 are also tracked in record 640. At this point, the actions maintained in record 640 indicate that the edit made to slide 630 affects user 609 and the edit made to slide 631 does not affect user 609.

In this scenario, native application service 601 may then send a notification to user 609 indicating the edit made to slide 630 (updated statistics and pie chart) and may not indicate the edit made to slide 631. In this example, the notification is indicated to user 609 in the form of a summary card which indicates only those edits made to slide 630 in presentation 620. The summary slide is then displayed in user interface 610 to user 609.

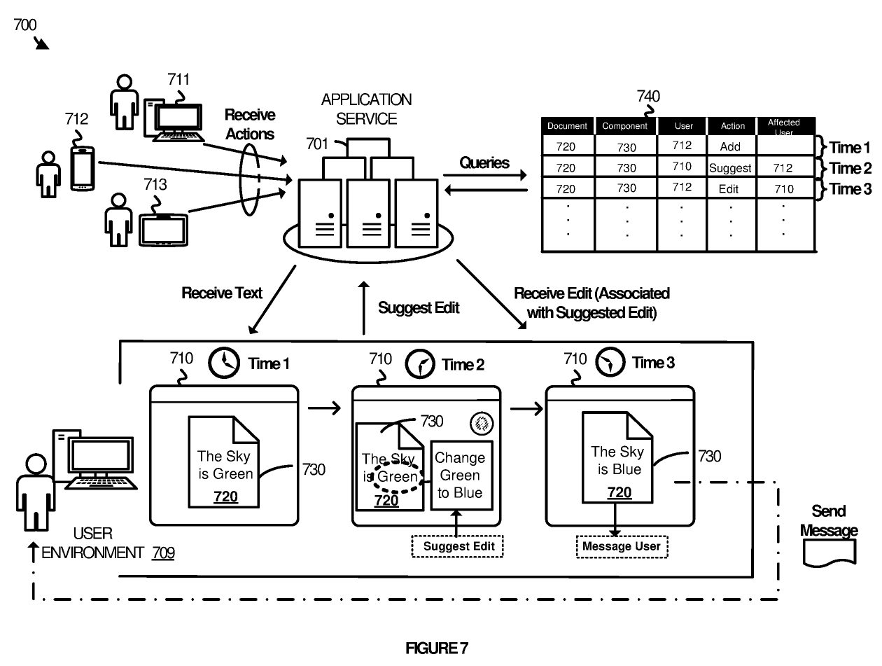

FIG. 7 illustrates an exemplary operational architecture for notifying a user of an action taken to a component of a collaborative document by another user that may be used in one or more scenarios of the present technology. FIG. 7 illustrates an operational scenario 700 that relates to what occurs when a suggested edit to a previously introduced component is added to the collaborative document by the user and the user desires to be alerted when the edit is completed in response to the suggested edit. Operational scenario 700 includes application service 701, user interface 710 in user environment 709, and other users 711-713. User interface 710 displays document 720 which is co-authored by user 709 and users 711-713. Operational scenario 700 also includes record 740 to track and maintain actions taken on components by users 709 and 711-713. In this example, record 740 is maintained at least in part in a cloud-based environment.

In a first operation, document 720 is created and shared in application service 701. Each of users 709 and 711-713 may then access and interact with document 720. In this scenario, document 720 is displayed to user 709 in user interface 710. In a next operation, at Time 1, user 712 adds a portion of text to document 720. For example, user 712 added “The Sky is Green” to create component 730. The portion of text may be added by user 712 in a local environment or in a cloud-based environment. The text is then accessible to be viewed by other users sharing co-authored document 720. For example, the user may type the text into a document sharing environment which may be accessed by users via application service 701.

In a next operation, user 709 takes an action to component 730 of collaborative document 720. The action is then tracked and maintained in record 740. For example, at Time 1, record 740 indicates that component 730 has been added to document 720 by user 712. At Time 2, user 709 adds a suggested edit to component 730. For example, after seeing that user 712 has mistakenly written that “The Sky is Green” instead of writing that “The Sky is Blue,” user 709 suggests that the word “Green” should be edited to say “Blue.” Once again, record 740 tracks the suggested edit to component 730. At Time 3, user 712 edits component 730 in document 720 based on the suggested edit received from user 709. These edits are then synchronized across each user version of collaborative document 720. The action taken to component 730 is also tracked in record 740. At this point, the actions maintained in record 740 indicate that the edit made to component 730 affects user 709.

In this example scenario, application service 701 may then send a notification to user 709 indicating the edit made to component 730 in response to the suggested edit associated with user 709 has been made. In a final operation, the notification is indicated to user 709 in the form of an email message. The email message indicates that an edit has been made to component 730 which was suggested by user 709 and that therefore, user 709 may be more interested in this edit than other actions made to other components of collaborative document 720.

FIG. 8 illustrates computing system 801, which is representative of any system or visual representation of systems in which the various applications, services, scenarios, and processes disclosed herein may be implemented. Examples of computing system 801 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes process 806, which is representative of the processes discussed with respect to the preceding FIGS. 1-7, including notifying process 200. When executed by processing system 802 to enhance an application, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, graphical processing unites, application specific processors, and logic devices, as well as any other type of processing device, combination, or variation.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. Software 805 may include program instructions for implementing notifying process 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtual machine software, or other application software, in addition to or that include process 806. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system to enhance a service for notifying a user of another user's actions on a component of a collaborative document. Indeed, encoding software 805 on storage system 803 may transform the physical structure of storage system 803. The specific transformation of the physical structure may depend on various factors in different implementations of this description. Such factors may include, but are not limited to, the technology used to implement the storage media of storage system 803 and whether the computer-storage media are characterized as primary or secondary storage, as well as other factors.

If the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here. User interface system 809 may also include associated user interface software executable by processing system 802 in support of the various user input and output devices discussed above.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

In any of the aforementioned examples in which data, content, or any other type of information is exchanged, the exchange of information may occur in accordance with any of a variety of protocols, including FTP (file transfer protocol), HTTP (hypertext transfer protocol), HTTPS, REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. Those skilled in the art will understand and appreciate that a method could alternatively be represented as a series of interrelated states or events, such as in a state diagram. Moreover, not all acts illustrated in a methodology may be required for a novel implementation.

### Example 1

A computer apparatus comprising: one or more computer readable storage media; a processing system operatively coupled to the one or more computer readable storage media; and program instructions stored on the one or more computer readable storage media that, when executed by the processing system, direct the processing system to at least: maintain a record of actions taken by users on a plurality of components of a collaborative document; receive an indication of an action taken by a user on a component of the collaborative document; evaluate the record to identify at least one other action taken by one other of the users on the component; and notify the one other user of the action taken by the user on the component of the collaborative document.

### Example 2

The computer apparatus of Example 1 wherein the at least one other action taken by the one other of the users on the component comprises at least one of an addition, an edit, an insertion, a copy and paste, a duplication, a rearrangement, or a deletion of at least a portion the component of the collaborative document.

### Example 3

The computer apparatus of Examples 1-2 wherein the at least one other action taken by the one other of the users on the component comprises at least one of a hover, a tap, a touch, a click, a screenshot, or a screen view for a timed duration on the component of the collaborative document.

### Example 4

The computer apparatus of Examples 1-3 wherein: the at least one other action taken by the one other of the users on the component comprises a suggested edit to the component of the collaborative document; and the action taken by the user on the component of the collaborative document comprises an edit in response to the suggested edit to the component of the collaborative document.

### Example 5

The computer apparatus of Examples 1-4 wherein to notify the one other user of the action taken by the user comprises the processing system directed to indicate a typographical variation on the component of the collaborative document.

### Example 6

The computer apparatus of Examples 1-5 wherein to notify the one other user of the action taken by the user comprises the processing system directed to surface a summary of the action taken by the user on the component of the collaborative document.

### Example 7

The computer apparatus of Examples 1-6 wherein to notify the one other user of the action taken by the user comprises the processing system directed to transfer a message indicating the action taken by the user on the component of the collaborative document.

### Example 8

The computer apparatus of Examples 1-7 wherein: to evaluate the record to identify the at least one other action taken by one other of the users on the component comprises the processing system directed to evaluate the record to identify a plurality of other actions taken by the other users on the component; and to notify the one other user of the action taken by the user on the component comprises the processing system directed to notify each of the other identified users of the action taken by the user on the component of the collaborative document.

### Example 9

The computer apparatus of Examples 1-8 wherein the component comprises at least a portion of text, a data entity card, an image, a table, a graph, an audio file, or a video clip.

### Example 10

A method comprising: maintaining a record of actions taken by users on a plurality of components of a collaborative document; receiving an indication of an action taken by a user on a component of the collaborative document; evaluating the record to identify at least one other action taken by one other of the users on the component; and notifying the one other user of the action taken by the user on the component of the collaborative document.

### Example 11

The method of Example 10 wherein the at least one other action taken by the one other of the users on the component comprises at least one of an addition, an edit, an insertion, a copy and paste, a duplication, a rearrangement, or a deletion of at least a portion of the component of the collaborative document.

### Example 12

The method of Examples 10-11 wherein the at least one other action taken by the one other of the users on the component comprises at least one of a hover, a tap, a touch, a click, a screenshot, or a screen view for a timed duration on the component of the collaborative document.

### Example 13

The method of Examples 10-12 wherein: the at least one other action taken by the one other of the users on the component comprises a suggested edit to the component of the collaborative document; and the action taken by the user on the component of the collaborative document comprises an edit in response to the suggested edit to the component of the collaborative document.

### Example 14

The method of Examples 10-13 wherein notifying the one other user of the action taken by the user comprises indicating a typographical variation on the component of the collaborative document.

### Example 15

The method of Examples 10-14 wherein notifying the one other user of the action taken by the user comprises surfacing a summary of the action taken by the user on the component of the collaborative document.

### Example 16

The method of Examples 10-15 wherein notifying the one other user of the action taken by the user comprises transferring a message indicating the action taken by the user on the component of the collaborative document.

### Example 17

The method of Examples 10-16 wherein: evaluating the record to identify at least one other action taken by the one other of the users on the component comprises evaluating the record to identify a plurality of other actions taken by the other users on the component; and notifying the one other user of the action taken by the user on the component comprises notifying each of the other identified users of the action taken by the user on the component of the collaborative document.

### Example 18

The method of Examples 10-17 wherein the component comprises at least a portion of text, a data entity card, an image, a table, a graph, an audio file, or a video clip.

### Example 19

One or more computer readable storage media having program instructions stored thereon, wherein the program instructions, when executed by a processing system, direct the processing system to at least: maintain a record of actions taken by users on a plurality of components of a collaborative document; receive an indication of an action taken by a user on a component of the collaborative document; evaluate the record to identify at least one other action taken by one other of the users on the component; and notify the one other user of the action taken by the user on the component of the collaborative document.

### Example 20

The one or more computer readable storage media of Example 19 wherein the at least one other action taken by the one other of the users on the component comprises at least one of an addition, an edit, a hover, a tap, a click, a screen view for a timed duration, or a suggested edit to the component of the collaborative document.

What is claimed is:

1. A computer apparatus comprising:
one or more computer readable storage media;
a processing system operatively coupled to the one or more computer readable storage media; and
program instructions stored on the one or more computer readable storage media that, when executed by the processing system, direct the processing system to at least:
maintain a record of actions taken by users on a plurality of components of a collaborative document;
receive an indication of an action taken by a user on a component of the collaborative document;
evaluate the record to identify at least one other action taken by one other of the users on the component; and
notify the one other user of the action taken by the user on the component of the collaborative document.

2. The computer apparatus of claim 1 wherein the at least one other action taken by the one other of the users on the component comprises at least one of an addition, an edit, an insertion, a copy and paste, a duplication, a rearrangement, or a deletion of at least a portion of the component of the collaborative document.

3. The computer apparatus of claim 1 wherein the at least one other action taken by the one other of the users on the component comprises at least one of a hover, a tap, a touch, a click, a screenshot, or a screen view for a timed duration on the component of the collaborative document.

4. The computer apparatus of claim 1 wherein:
the at least one other action taken by the one other of the users on the component comprises a suggested edit to the component of the collaborative document; and
the action taken by the user on the component of the collaborative document comprises an edit in response to the suggested edit to the component of the collaborative document.

5. The computer apparatus of claim 1 wherein to notify the one other user of the action taken by the user comprises the processing system directed to indicate a typographical variation on the component of the collaborative document.

6. The computer apparatus of claim 1 wherein to notify the one other user of the action taken by the user comprises the processing system directed to surface a summary of the action taken by the user on the component of the collaborative document.

7. The computer apparatus of claim 1 wherein to notify the one other user of the action taken by the user comprises the processing system directed to transfer a message indicating the action taken by the user on the component of the collaborative document.

8. The computer apparatus of claim 1 wherein:
to evaluate the record to identify the at least one other action taken by one other of the users on the component comprises the processing system directed to evaluate the record to identify a plurality of other actions taken by the other users on the component; and
to notify the one other user of the action taken by the user on the component comprises the processing system directed to notify each of the other identified users of the action taken by the user on the component of the collaborative document.

9. The computer apparatus of claim 1 wherein the component comprises at least a portion of text, a data entity card, an image, a table, a graph, an audio file, or a video clip.

10. A method comprising:
maintaining a record of actions taken by users on a plurality of components of a collaborative document;
receiving an indication of an action taken by a user on a component of the collaborative document;
evaluating the record to identify at least one other action taken by one other of the users on the component; and
notifying the one other user of the action taken by the user on the component of the collaborative document.

11. The method of claim 10 wherein the at least one other action taken by the one other of the users on the component comprises at least one of an addition, an edit, an insertion, a copy and paste, a duplication, a rearrangement, or a deletion of at least a portion of the component of the collaborative document.

12. The method of claim 10 wherein the at least one other action taken by the one other of the users on the component comprises at least one of a hover, a tap, a click, a touch, a screenshot, or a screen view for a timed duration on the component of the collaborative document.

13. The method of claim 10 wherein:
the at least one other action taken by the one other of the users on the component comprises a suggested edit to the component of the collaborative document; and
the action taken by the user on the component of the collaborative document comprises an edit in response to the suggested edit to the component of the collaborative document.

14. The method of claim 10 wherein notifying the one other user of the action taken by the user comprises indicating a typographical variation on the component of the collaborative document.

15. The method of claim 10 wherein notifying the one other user of the action taken by the user comprises surfacing a summary of the action taken by the user on the component of the collaborative document.

16. The method of claim 10 wherein notifying the one other user of the action taken by the user comprises transferring a message indicating the action taken by the user on the component of the collaborative document.

17. The method of claim 10 wherein:
evaluating the record to identify at least one other action taken by the one other of the users on the component comprises evaluating the record to identify a plurality of other actions taken by the other users on the component; and
notifying the one other user of the action taken by the user on the component comprises notifying each of the other identified users of the action taken by the user on the component of the collaborative document.

18. The method of claim 10 wherein the component comprises at least a portion of text, a data entity card, an image, a table, a graph, an audio file, or a video clip.

19. One or more computer readable storage media having program instructions stored thereon, wherein the program instructions, when executed by a processing system, direct the processing system to at least:
maintain a record of actions taken by users on a plurality of components of a collaborative document;
receive an indication of an action taken by a user on a component of the collaborative document;
evaluate the record to identify at least one other action taken by one other of the users on the component; and
notify the one other user of the action taken by the user on the component of the collaborative document.

20. The one or more computer readable storage media of claim 19 wherein the at least one other action taken by the one other of the users on the component comprises at least one of an addition, an edit, a copy and paste, a duplication, a rearrangement, a deletion of at least a portion, a hover, a tap, a touch a click, screenshot, a screen view for a timed duration, or a suggested edit to the component of the collaborative document.
